(19) United States
(12) Patent Application Publication
(10) Pub. No.: US 2005/0096984 A1
(43) Pub. Date: May 5, 2005

(54) Gas cap cover

(76) Inventor: Albert S. Thompson III, Ft. Worth, TX (US)

Correspondence Address: Eric T. Jones;Reising, Ethington, Bames, Kisselle, P.C., P.O. Box 4390, Troy, MI, 48099-4390, US

(21) Appl. No.: 11/007,416

(22) Filed: Dec. 8, 2004

Related U.S. Application Data
(62) Division of application No. 09/748,496, filed on Dec. 22, 2000, now abandoned.

(51) Int. Cl. G06F 17/60; B65D 51/16

(52) U.S. Cl. 705/14

(57) ABSTRACT

A gas cap cover device for an automotive vehicle gas cap includes a shell configured to be disposed over a portion of a gas cap. A connector is supported on the shell and is configured to engage the gas cap and cause the gas cap to rotate when the cover device is rotated. A message-bearing element is supported on the cover device and is configured to display a message formulated to influence a vehicle operator to take some action. In addition, a method for reducing emissions from automotive vehicles includes replacing old leaking gas caps with new gas caps that each include a message advertising a product or service or encouraging participation in activities related to automotive emissions reduction. The message may be included on the message-bearing element of the gas cap cover device.

This application is based on U.S. patent application Ser. No. 09/748,496, filed Dec. 22, 2000.

### TECHNICAL FIELD

This invention relates to a cover for an automotive fuel tank cap and methods for reducing the emission of volatile organic compounds (VOCs) in the form of fuel vapor emissions.

### BACKGROUND OF THE INVENTION

Automotive vehicle fuel storage systems typically include filler tubes that extend from fuel tanks to receptacles formed in vehicle fenders or other exterior body panels. Many such filler tubes include neck members that are attached to the distal ends of the tubes and are sometimes provided with tubular cylindrical fittings with internal threads. The threaded fittings are configured to receive an externally threaded cylindrical portion of a fuel tank cap in threaded engagement.

Another common fuel tank cap configuration includes radially inwardly extending tabs configured to engage flanges that extend radially outward from filler tubes adjacent their distal ends.

It is known for fuel tank caps, i.e., gas caps, to include annular rubber sealing rings. These rings are configured and positioned to make sealing contact with circular rims disposed at the distal ends of filler tubes or filler tube neck members. Contact between the rubber sealing rings and the circular rims prevents volatile fuel vapors from escaping the fuel storage system. It is also known for such rubber sealing rings to deteriorate with age and repeated use and to lose their ability to effectively seal-in fuel vapors. For this reason it is desirable to replace such fuel tank caps at regular intervals to reduce the amount of fuel vapor escaping into the atmosphere. Unfortunately, individual automotive vehicle owners have little incentive to invest the time and money necessary to locate, purchase and install new fuel tank caps. This is especially true in view of the fact that individual automobile owners tend to view vapor emissions from their personal vehicles as being insignificant.

It is also known for such fuel tank caps to be constructed with the automotive vehicle manufacturer's name and/or trademark included in an outer surface of the cap. Unfortunately, the inclusion of the automotive vehicle manufacturer's name and/or trademark does not serve to persuade or remind a vehicle owner to take steps to reduce vapor emissions from the fuel storage system of his or her vehicle.

Most, if not all states have vehicle inspection and maintenance (I&M) programs that encourage and/or force vehicle owners to keep their vehicles running as “clean” as possible. During the early development of the State of Texas' Inspection and Maintenance (I&M) programs, the focus was on inspection rather than maintenance.

The question was “how do we get all of the cars to participate in the inspection process?” Neither the EPA, the State of Texas nor any of the other States have directed any appreciable effort to insure compliance by showing members of the public how such programs were in their individual best interests. Most of the I&M program administrators apparently assumed that because it was the law, the motoring public would obediently line up for any form of test that was developed. This assumption turned out to be unwarranted even in the case of the most simple of tail pipe tests, the “Bar84.” Even today, despite the almost nation-wide failure of a centralized test known as “I/M 240” and the public's negative reaction to being forced to “go get a test,” many program administrators still fail to see the need to actually promote and encourage public participation in such programs.

If any form of mandated automobile testing is to be successful, the public must accept and participate in it. To help reduce tail-pipe emissions, it would be helpful to incorporate a system of recurring reminders into the testing procedures. These reminders can create a public perception that participation will result in actual benefits. To be effective, any I&M program should contain such reminders. To approach 100% participation the public must perceive some value in the test and must be reminded to participate.

For many reasons, members of the public currently evade the test. Some fear failure and expensive repairs, some are angry at being coerced to participate against their will and some are afraid of the cost of the test itself. In addition, most do not understand why they must do it at all.

Public education on environmental issues is one of the requirements of the 1990 Clean Air Act. Most states fail to develop and implement an effective mechanism to carry out this mandate. The mechanisms that states have put in place, as with most information programs, are selective. Some are of the generic message type and suggest the need to act without providing a cost-effective remedy. Some rely on emotion or guilt, but otherwise fail to tell the public why they should be part of a program to address the problem. They typically say, “Do your share for cleaner air,” but fail to tell people how.

Under provisions of The Clean Air Act, a state may develop and follow a State Implementation Plan (SIP) that details how that state deals with the problem of measuring and reducing pollution. Under such a plan, environmental divisions or local councils of the governments of affected cities control distribution and private exchanges of emission reduction credits (ERCs). Such credit distribution and exchange programs are used to both educate the public and to promote the most cost-effective pollution mitigation techniques—especially in cities that the EPA has designated as having unhealthy air. ERCs earned through reduction of mobile emissions, e.g., automobile emissions, are termed mobile emission credits or “MERCs.” ERCs and MERCs are measured either in tons of reduced emissions or in dollars per ton of reduced emissions. ERCs and MERCs are awarded to an entity for each ton of emission reduction that the entity can prove that it is responsible for. In addition, ERCs and/or MERCs can be awarded to entities that implement and/or operate certain environmental educational programs.

Private and governmental entities sometimes trade ERCs on an open market under the State Implementation Plans. Both “point sources” of pollution and “mobile sources” of pollution benefit from trading MERCs and ERCS. Point sources of pollution are typically harder-hit by requirements to reduce pollution than are mobile sources. Point sources are pollutant-producing entities that exist at discrete stationary physical addresses while mobile sources are pollutant producers, such as automobiles, that move as they emit. The EPA usually monitors point sources closely. The clean-up requirements are more easily enforced against point sources, but place heavy and possibly disproportionate economic burdens on such entities. Most of the cost of point source pollution clean up enforcement is eventually passed on to the purchasing public in the form of price increases.

ERC trading encourages private and governmental entities to continue reducing pollution while easing the economic burden on point sources and thereby reducing costs passed on indirectly to the purchasing public. This is done by encouraging the development and use of lower cost pollution reduction methods through open market trading of pollution-reduction credits. The open market rewards entities that implement low-cost methods of reducing large amounts of pollutant emissions.

What is needed is an inexpensive—or even a profitable way of providing consumers with fuel tank caps that would remind and encourage consumers to renew the caps at regular intervals. What is also needed is a way for governments to deliver messages that would promote public participation in vehicle inspection and maintenance programs.

### BRIEF DESCRIPTION OF THE DRAWINGS

FIG. 1 is a perspective view of a first embodiment of a gas cap cover constructed according to the invention;

FIG. 2 is a bottom view of the gas cap cover of FIG. 1;

FIG. 3 is a front view of the gas cap cover of FIG. 1;

FIG. 4 is a perspective view of a second embodiment of a gas cap cover constructed according to the invention;

FIG. 5 is a bottom view of the gas cap cover of FIG. 4;

FIG. 6 is a front view of the gas cap cover of FIG. 4;

FIG. 7 is a perspective view of a third embodiment of a gas cap cover constructed according to the invention;

FIG. 8 is a bottom view of the gas cap cover of FIG. 7;

FIG. 9 is a front view of the gas cap cover of FIG. 7; and

FIG. 10 is a perspective view of a fourth embodiment of the gas cap cover constructed according to the invention and engaged with a wrench or “cheater bar”.

### DETAILED DESCRIPTION OF THE PREFERRED EMBODIMENTS

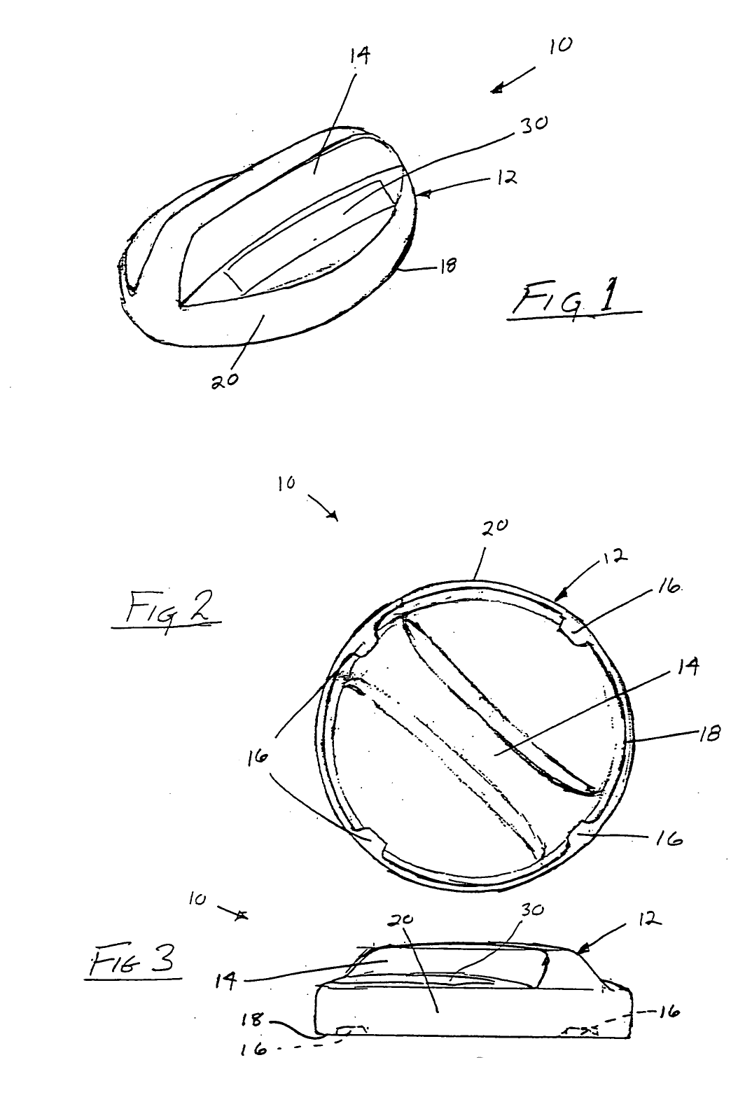

A first embodiment of a fuel tank cap overlay or cover constructed according to the invention is generally indicated at 10 in FIGS. 1-3.

A second embodiment of a fuel tank cover is generally indicated at 10′ in FIGS. 4-6. Reference numerals accompanied by a prime (′) designation in FIGS. 4-6 designate alternative configurations of each element that are common to the first embodiment. Unless the description indicates otherwise, where a reference numeral without a prime designation refers to an element of the first embodiment, we intend the description of that element to apply equally to elements in FIGS. 4-6 indicated by the same reference numeral with a prime designation.

A third embodiment of a fuel tank cover is generally indicated at 10″ in FIGS. 7-9. Reference numerals accompanied by a double prime. (″) designation in FIGS. 4-6 designate alternative configurations of each element that are common to the first embodiment. Unless the description indicates otherwise, where a reference numeral without a double prime designation refers to an element of the first embodiment, we intend the description of that element to apply equally to elements in FIGS. 7-9 indicated by the same reference numeral with a prime designation.

The first embodiment of the fuel tank cap cover, shown at 10 in FIGS. 1-3, includes a hollow, generally disk-shaped plastic shell 12 configured to be removably installed over a portion of a gas cap. More specifically, the shell 12 is formed to snap into place over a fuel tank cap (not shown) and comprises a plastic wall shaped to complement the shape of a portion of the gas cap

Supported on the shell 12 is a connector comprising a detent formed into the shell and configured to engage at least one surface of the gas cap to allow an operator to apply turning force to the cap through the cover device. As shown in FIGS. 1-3, the connector detent includes a handle portion 14 shaped to fit over a handle portion of a fuel tank cap. The handle portion 14 is configured to rotationally engage the gas cap handle and cause the gas cap to rotate when the cover is rotated.

The shell 12 also includes four retainer tabs 16 that extend integrally and radially inwardly from around a bottom edge 18 of a circumferential sidewall portion 20 of the shell 12. The tabs 16 are positioned to flex upwardly as the cover 10 is pushed over a gas cap. The tabs 16 then snap back to their original inwardly-extending position as the bottom edge 18 of the sidewall 20 passes a circular peripheral edge (or similar structure) of the gas cap, securing the cover 10 on the cap. The entire shell 12, including handle portion 14, sidewall 20 and tabs 16 are integrally formed as a single unitary piece.

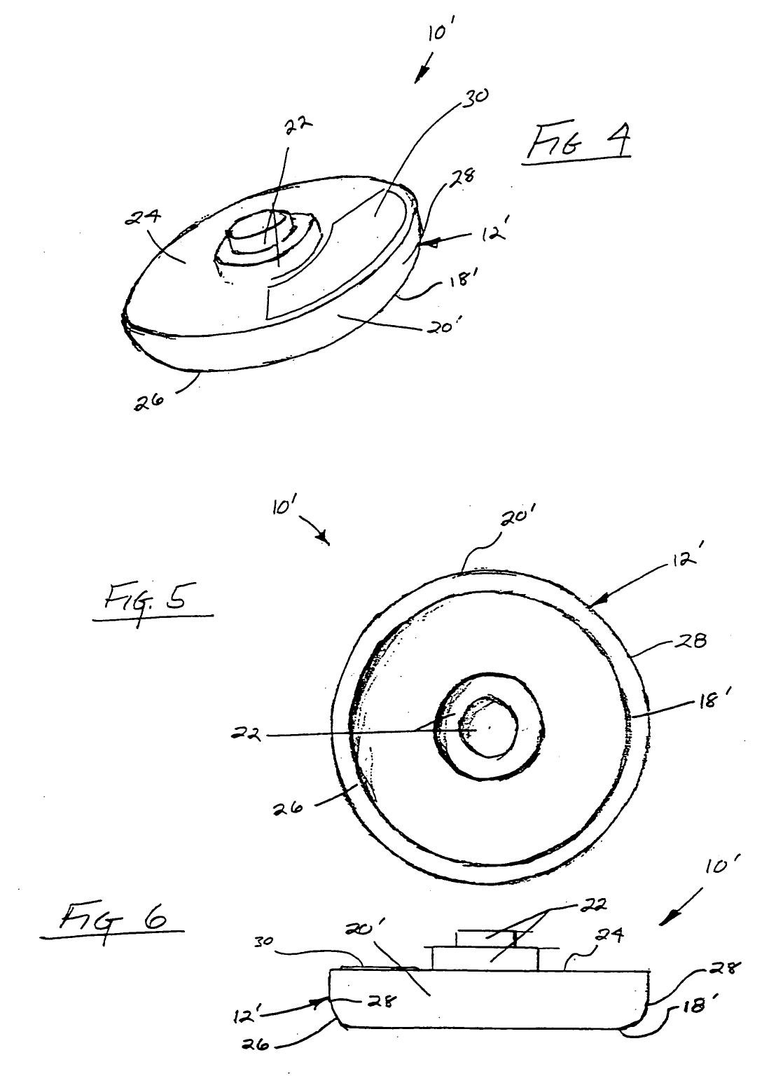

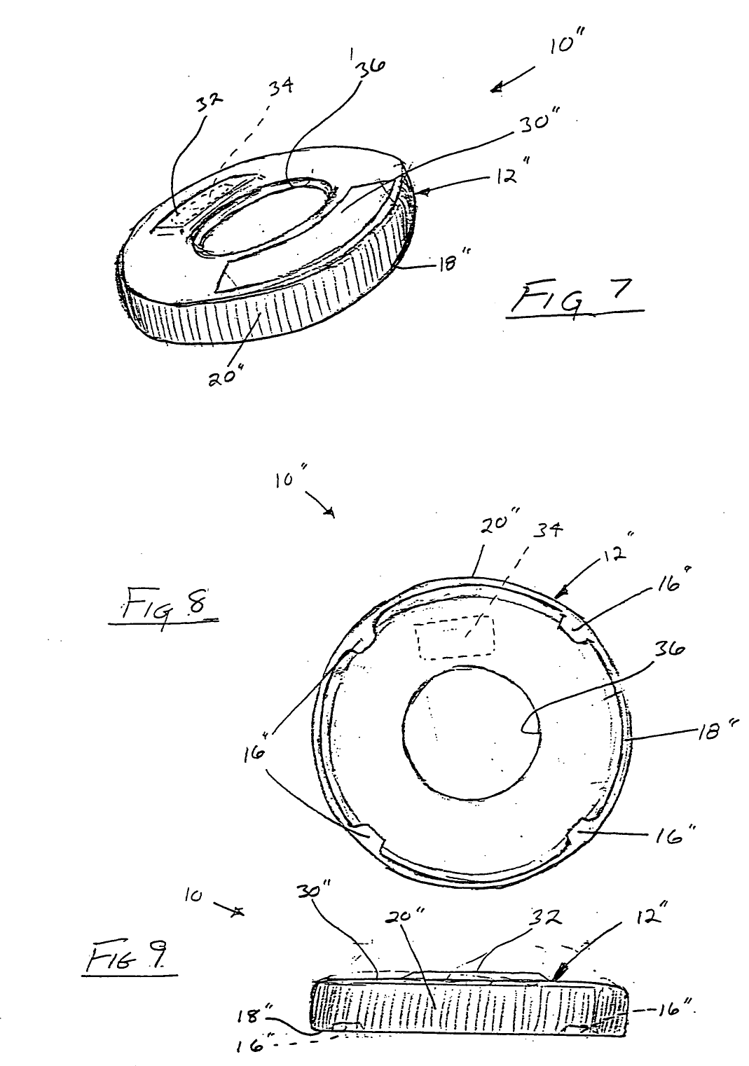

A variety of forming methods are known in the art and allow for many and various shapes and sizes of gas cap covers to snap over various sizes and shapes of gas caps. For example, as shown in FIGS. 4-6, the second embodiment of the fuel tank cap cover 10′ includes a pair of concentric cylindrical protrusions 22 extending “wedding-cake” style from a circular upper surface 24 of the cover 10. The protrusions 22 are configured to fit over lock cylinders of locking-type gas caps and the like. As best shown in FIG. 6, a circumferential sidewall 20′ of the second embodiment cover 10′ includes a “rolled-under” profile 26. In other words, the diameter of the circumferential sidewall 20′ decreases gradually from an approximate vertical midpoint 28 of the sidewall 20′ to a bottom edge 18′ of the sidewall 20′, the bottom edge 18′ having the smallest sidewall diameter. Similar to the tabs 16 of the first embodiment, the rolled-under portion 26 of the sidewall 20′ of the second embodiment is configured to snap into place as the bottom edge 18′ of the sidewall 20′ passes a circular peripheral edge of the gas cap. This secures the cover 10′ onto the cap.

In other embodiments, the gas cap cover 10 may be formed to include a storage compartment. The storage compartment may be used to releasably hold a plastic key that is capable of opening a car door.

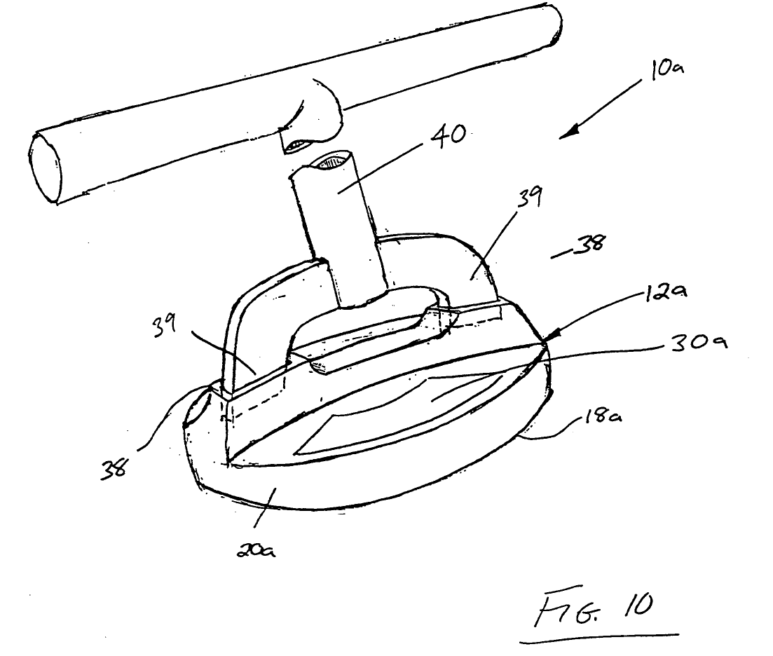

According to the third embodiment of the gas cap shown in FIGS. 7-9, the cover 10″ is configured to accommodate a gas cap having a refueling door or receptacle that opens when a refueling nozzle from an automated or robotic refueling device is inserted into it. Because it overlies the gas cap when installed, the top of the gas cap cover 10″ is formed to include a housing 32 for an electromagnetic energy transmitter and/or receiver 34 to aid in directing a robotic refueling device. This would assist fuel-dispensing nozzles controlled by robotic refueling devices to locate and engage the refueling receptacle in the gas cap. The transmitter and/or receive are embedded in the shell 12″ of the gas cap cover 10″ when the cover 10″ is formed as shown in FIGS. 7 and 8. The gas cap cover 10″ is shaped to accommodate a refueling receptacle formed into the gas cap. More specifically, as shown in FIGS. 7 and 8, a circular upper surface of the cover includes a hole 36 configured to align with and leave uncovered a refueling receptacle in a gas cap to be covered. In other embodiments the transmitter or receiver may be supported in any suitable location in or on the shell 12″ of the gas cap cover 10″.

As shown in FIG. 10, the fourth embodiment of the gas cap cover 10a is configured to include two receptacles 38 configured to receive a pair of tongs 39 extending from a wrench or “cheater bar” 40. Configuring the cover 10a to engage a tool similar to the one shown at 40 in FIG. 10 would allow older and infirm vehicle operators to acquire sufficient mechanical advantage to fully secure a gas cap and to remove a tightly secured gas cap. The receptacles 38 are configured to transmit turning forces from the wrench to a gas cap through the cover 10a after the cover is snapped over the gas cap. Such a configuration would reduce VOC by allowing older drivers to screw their gas caps tightly into place without fear of being unable to remove the gas cap at their next fill-up. In other embodiments there may be only a single receptacle, and the receptacle and tool may be of any suitable configuration to provide mechanical advantage.

The cap cover 10 can be constructed from one or more of a number of suitable materials to include vinyl. The material making up the cover 10 can be a clear colorless vinyl, a clear colored vinyl, or a colored opaque vinyl. Vinyl lends itself to cost-effective vacuum forming and minimum waste of materials. Further, vinyl is a product that can be recycled. Printing and other forms of affixing messages are generally compatible with vinyl. The use of holograms is also compatible with vinyl, as vinyl will accept most glues and other adhesives.

The gas cap cover 10 is produced by well-known vacuum forming techniques. Injection molding may alternatively be employed if the need for increased strength or other undefined measures arise.

The invention also includes methods for reducing pollution by earning and trading in mobile emissions reduction credits (MERCs) through the installation of new gas caps and or gas cap covers bearing certain advertising and/or environmental messages.

According to the invention, MERCs are earned by an entity based on the number of gas cap covers 10 and/or new gas caps that the entity has installed on automotive fuel tank fill tubes. With respect to the replacement of old, leaky gas caps, credits are awarded based on how many fewer tons of Volatile Organic Compounds (VOCs) will be released into the atmosphere. With respect to the message affixed to each new gas cap, the installing entity earns a pre-determined credit for contributing to public education and awareness. An entity could also establish a “Savings Account” for such credits to help meet future, more stringent, emission reduction standards.

One cost-effective way for an entity such as a state government to get an environmental message out to the public would be to install new message-bearing gas caps or to install message-bearing gas cap covers 10 over old gas caps in conjunction with a required annual safety inspection. During the annual safety inspection, such a gas cap cover 10 or new gas cap could bear a message reminding the public of the due date of their next safety inspection. If an emission test is part of the annual safety inspection, then the entity could also claim pollution reduction credits as described above. Such a system of reminders could conceivably generate considerable additional revenue for a State. The additional revenue would come in the form of interest earned on inspection fees that are paid on time rather than late.

In some states, all new cars carry a two-year safety and/or emission certificate. States could claim extra pollution reduction credits by installing message-bearing gas caps or gas cap covers 10 on new automobiles. Since most cars are driven an average of 15,000 miles per year, after two years of driving many cars develop emission-related problems that do not create a noticeable driveability problem. In other words, an operator would typically have no way of knowing, after two years of driving, that his or her vehicle might be emitting unacceptable amounts of pollutants into the atmosphere. Therefore, a gas cap or gas cap cover 10 that includes a simple reminder for such vehicle operators to have their vehicle tuned up or to have its emissions checked by a certain date could be installed on each new vehicle. Under this type of program, the entity providing the caps or covers could qualify for extra pollution reduction credits from the EPA. A gas cap or gas cap cover 10 exchange program could also be used to develop a general maintenance awareness program for all vehicles and, again, could qualify the State to receive extra MERCs.

The EPA could also use a system of this type to help deliver their public service messages. For example, working with auto makers, a gas cap or gas cap cover 10 could be used to send a message such as “Give a Hoot, Don't Pollute.” For example, such a message may be included on a message-bearing element such as a label, shown at 30 in. FIGS. 1 and 3, affixed to a surface of a gas cap cover 10.

The message-bearing element may be configured to display a message formulated to influence the vehicle operator to take any one or more of a number of different actions. For example, Government and private entities can use the exterior surfaces and interior surfaces of the above-described gas cap cover 10, or the gas cap itself, to deliver messages to the public. These surfaces will be able to accept such message-carrying structures as decals, stickers, paints, foils, laminates, inks, overlays. In addition, the message-carrying element may comprise a portion of the gas cap cover shell.

Service marks, trademarks, icons, logos, or trademark and copyright symbols could be affixed to the gas cap cover to identify a company that sells or markets any goods or services. Business addresses or locations, service performed, telephone numbers or products sold may also be displayed. In addition, advertising messages implying that a certain product is superior such as “Please use Texaco® gas” may be affixed to the gas cap cover. More than one message may be applied, such as: “Check your oil,” “use Pennzoil®.”

The message on the cap cover 10 may also carry information regarding discounted services such as “$3.00 off at Jiffylube®”, or an environmental awareness message such as “Do your share for cleaner air,” “Don't Mess with Texas,” or “Tune up your car Today.” The cap cover may also bear state hot line telephone numbers for environmental concerns.

The cap cover 10 may also carry messages reminding vehicle owners of state requirements such as “Safety Inspection due (month and year).” Such reminder messages could be used to complement emission program messages that States develop such as “Texans doing their share for cleaner air.”

Benefits of the present invention include a reduction in paper advertising expenses for entities that use the gas cap cover to get their message out. In addition, private entities that participate in gas cap replacement programs can boast of their participation in an environmentally friendly activity.

The EPA has featured public service messages on television that state that a gas cap has a useful life of approximately three years. Therefore, government or private entities could earn pollution-reduction credits by requiring and/or installing gas caps that bear their own expiration date, i.e., three years from the date of first use on an automobile. When a private entity, such as an automotive engine-oil replacement facility, provides the message-bearing caps during the course of a regular oil change, the caps may also carry an advertisement for that private entity. The new caps may also include information reminding the vehicle operator when he or she should return for his or her next oil change. The private entity may then establish a program to automatically replace gas caps at regular intervals in conjunction with future oil changes. Vehicle owners will view these messages an average of 3.5 times a week, 104 times a year and 312 times during the useful life of each gas cap. A gas cap replacement program of this type would provide a private entity with the double benefit of providing advertising benefit and earning pollution reduction credits.

According to the invention, entities that can reduce large amounts of pollution at very low cost by merely replacing gas caps at regular intervals, can sell the pollution-reduction credits they've earned to point sources. The “gas cap replacers” can sell the credits at a price greater than their cost and less than what it would cost the purchaser to reduce an equivalent amount of emissions. Therefore, through open market trading, the point sources, who must often spend vast amounts of money to effect incremental reductions in emissions, can use the purchased credits to meet their own emission-reduction requirements.

An example of how pollution-reduction credits can be calculated for a private entity that implements a gas cap replacement and/or give-away program is as follows:
1. The entity removes the old gas cap (if there is one) and replaces it with-new gas cap.
2. The entity tracks the identity of each vehicle receiving a new gas cap by recording each vehicle's identification number and records which vehicles were missing gas caps.
3. The entity has each vehicle owner sign a statement verifying that the entity has installed a new gas cap on his or her vehicle and also stating whether or not the vehicle was missing a gas cap when the new gas cap was mounted.
4. The entity collects and tests all of the old caps, recording their respective leakage rates and/or failure rates.
5. The entity uses an EPA-approved formula to calculate the tonnage of emissions that the vehicles would have released through the old caps had the entity not replaced the old caps.
6. The entity estimates the tonnage of emissions that vehicles without caps would have released by multiplying an average emission value for all the old caps by 6.
7. The entity then calculates and records a total MERC value as being the sum of the projected emission reduction tonnage of the vehicles that had gas caps and the projected emission reduction tonnage of the vehicles that did not have gas caps.
8. The entity may then multiply the emission reduction tonnage by an EPA-determined “present value” of an ERC or a MERC. The GAO calculates the present value of an emission credit based on information the GAO has collected on the average cost of reducing emissions. The GAO has calculated the present value of a MERC to be approximately $6500. Therefore, if the projected emission reduction tonnage for the gas cap replacement program was, for example, 51 tons, then the total MERC value would be $331,500.00 (51 tons×$6500.00). Therefore, an ERC or a MERC may be expressed either in units of tons of emission reduction or in units of dollars per ton of emission reduction.

States, rather than federal or local governments, usually administer mobile source emission reduction. However, if a company so desired, it could go outside the confines of the SIP to trade for and/or gather MERCs from elsewhere in the country. Again, gas cap and gas cap cover replacement systems are a cost-effective way to do this. By implementing a system according to the invention, with administration and purchase costs, entities can reduce pollution at an average cost of $125.00 per ton—far less than the $6500 per ton present value established by the GAO.

By organizing as a not-for-profit corporation, it is possible for an entity to donate money to environmental awareness projects. Such donations are tax deductible. In addition, a non-profit entity of this type could advertise and earn MERCs by giving away gas caps bearing the company logo. The entity could then turn around and sell the MERCs to companies, e.g., point source polluters, that are in need of emission reduction credits to meet emission reduction standards. In this way, cost savings could be passed on to the company that purchases these reduction credits so long as it is less expensive to purchase the credits than it is to install the costly emission reduction devices necessary to reduce the MERC-purchasing company's own emissions by an equivalent amount.

Currently, approximately 92% of all cars have gas caps on them—most of those caps being original equipment. Most members of the public will therefore view a gas cap whenever they fuel their cars. Most members of the public refuel their cars an average of 3.5 times a week. If messages were affixed to the gas caps, the average car owner would view the message on his or her gas cap about 105 times a year. Therefore, among other things, the present invention includes a cost effective, common sense way to repeatedly expose the public to a message—a message that can be used, among other things, to increase public participation in inspection and maintenance (I&M) programs (such as replacing old gas caps) as well as to encourage the purchase of a particular product. According to the open market pollution reduction credit training method of the present invention, the entity providing the gas caps may also take earn pollution reduction credits.

The inventor's notes included in the attached appendix contain a further disclosure of the invention. I intend to include the appendix as part of this provisional patent application.

This is an illustrative description of the invention using words of description rather than of limitation. Obviously, many modifications and variations of this invention are possible in light of the above teachings.

1-6. (canceled)

7. A gas cap cover device for an automotive gas cap; the cover device comprising:
a shell configured to be removably installed over a portion of a gas cap;
a connector supported on the shell and configured to rotationally engage the gas cap and cause the gas cap to rotate when the cover is rotated;
a message-bearing element supported on the shell and configured to display a message formulated to influence the vehicle operator to take some action; and
a hole in an upper surface of the cover device configured to align with and leave uncovered a refueling receptacle in a gas cap to be covered:

8. A gas cap cover device as defined in claim 7 including an electromagnetic energy transmitter supported on the shell and configured to aid in directing a robotic fueling device.

9. A gas cap cover device as defined in claim 1 further including a receptacle configured to engage a wrench and to transmit turning forces from the wrench to the cap through the cover device.

10-20. (canceled).
